(19) United States
(12) Patent Application Publication
(10) Pub. No.: US 2008/0134806 A1
(43) Pub. Date: Jun. 12, 2008

(54) Container system for dispensing a liquid

(75) Inventors: Lewis A. Capriccio, Westford, MA (US); Sridhar Iyengar, Salem, NH (US); David I. Nazzaro, Groveland, MA (US)

Correspondence Address: Marina Larson & Associates, LLC, P.O. BOX 4928, DILLON, CO, 80435, US

(73) Assignee: AGAMATRIX, INC., Salem, NH (US)

(21) Appl. No.: 11/567,419

(22) Filed: Dec. 6, 2006

(51) Int. Cl. B01L 3/00; B01L 3/02; G01N 1/38

(52) U.S. Cl. 73/863.21; 422/100; 422/102

(57) ABSTRACT

A container system for a liquid has an open-topped receptacle for receiving a liquid and a cover. The cover has an interior surface fitting on or within the open top of the receptacle and an exterior surface that it exposed when the cover is fitted to the open top of the receptacle. The cover also has an aspirating nipple formed therein. The aspirating nipple has a tube with an internal channel extending from the exterior of the cover into the receptacle for transferring liquid out of the receptacle and a gasket disposed on the exterior surface of the cover and surrounding the channel.

### BACKGROUND

The present invention is directed toward liquid container systems for dispensing liquid. In particular embodiments the containers are used in processes requiring highly precise and consistent measurements.

Various liquid dispensing systems are known and used to transfer fluid samples from receptacles, such as test tubes, vials or wells, to other receptacles or surfaces. One such automated system is disclosed in U.S. Pat. No. 5,055,263, issued to Meltzer, entitled “Automated Pipetting System.” This reference discloses a system wherein a plurality of hollow probes are used to transfer a plurality of fluid samples. A probe is dipped into the fluid repository and a volume of fluid is drawn into the probe using aspiration. The probe is retracted from the repository and repositioned above the receptacle or surface that will receive the fluid sample. The probe is lowered towards the surface and pressure is exerted against the fluid to force the fluid sample out of the probe and onto the surface.

Systems similar to and including the one described above are effective for transferring fluid samples from receptacles. However it has herein been found that the measurement accuracy, consistency, repeatability, and reliability of sample dispensing can be improved by using the container systems and methods of the present invention.

### SUMMARY OF INVENTION

The container systems and the methods of the present invention include a number of features which allow for measurement accuracy, consistency, repeatability, and reliability that are required in laboratory and manufacturing settings. These and other benefits are provided via liquid container systems having aspirating nipples that allow for the transfer of liquid from the container into a transferring tube (e.g. a pipette) without bringing the exterior of the tube in to contact with the liquid in the container. For example, in one embodiment, the present invention provides a container system that comprises:

an open-topped receptacle for receiving a liquid,

a cover, said cover having an interior surface fitting on or within the open top of the receptacle and an exterior surface that it exposed when the cover is fitted to the open top of the receptacle, said cover having an aspirating nipple formed therein,

wherein the aspirating nipple comprises a tube with an internal channel extending from the cover into the receptacle for transferring liquid out of the receptacle, and a gasket disposed on the exterior surface of the cover and surrounding the channel.

In a further embodiment the container system also comprises a pipette sized to engage the gasket, wherein when liquid is present in the receptacle and the pipette is engaged with the gasket, liquid is transferred from receptacle into the pipette without the exterior surface of the pipette being exposed to the liquid. By preventing the exterior surface of the pipette coming in contact with the liquid in the container the risk of additional/unwanted liquid applied to a testing area can be minimized. Further, using the container systems and methods of the present invention the pipette does not need to be wiped after/before each use.

### BRIEF DESCRIPTION OF DRAWINGS

FIG. 1A is an isometric view of a container system in accordance with the present invention.

FIG. 1B is an exploded side view of a container system in accordance with the present invention.

FIG. 1C is an top view of a container system in accordance with the present invention.

FIG. 2A is an cross-section view of a gasket in accordance with an embodiment of the present invention.

FIG. 2B is an cross-section view of a gasket in accordance with an embodiment of the present invention.

FIG. 2C is an cross-section view of a gasket in accordance with an embodiment of the present invention.

FIG. 3A is an isometric view of a container system in accordance with the present invention.

FIG. 3B is a side view of a pipette in accordance with the present invention.

FIG. 4 is an isometric view of a container system in accordance with the present invention.

FIG. 5A is an exploded isometric view of a container system in accordance with the present invention.

FIG. 5B is an exploded isometric view of a container system in accordance with the present invention.

FIG. 5C is an isometric view of a container system in accordance with the present invention.

FIG. 6 is an isometric view of a container system in accordance with the present invention.

FIG. 7 is an isometric view of a container system in accordance with the present invention.

FIG. 8 is a cross-section side view of a container system in accordance with the present invention.

### DETAILED DESCRIPTION

The container systems and the methods of the present invention include a number of features which allow for the measurement accuracy, repeatability, and reliability that is required in laboratory and manufacturing settings. These and other benefits are provided via container systems having aspirating nipples that allow for the transfer of liquid from the container into a transferring tube (e.g. a pipette) without bringing the exterior of the tube in contact with liquid in the container. By preventing the exterior surface of the tube from coming in contact with the liquid in the container the risk of additional/unwanted liquid applied to a testing area can be minimized. Further, using the container systems and methods of the present invention the transferring pipette does not need to be wiped after/during each use thereby saving time and wasted product, and the risk of contamination is reduced.

In the specification and the claims which follow, reference will be made to a number of terms which shall be defined to have the following meanings:

The open-topped receptacles of the present invention are formed to receive a liquid. The type of liquid is not particularly limited except with the proviso that the liquid may flow through the aspirating nipple from the receptacle to the exterior of the container through the gasket under desired operating conditions. The liquid may be a pure liquid or solution, mixture, emulsion, suspension in water, alcohol or other solvent. For example in one embodiment, the liquid is a chemical reagent (e.g. where the liquid comprises an oxidation/reduction enzyme or some other mediator).

The term “pipette” is used to described the transferring device used to engage the gasket of the aspirating nipple and to transfer liquid out of the receptacle through the internal channel of the nipple. The pipette is in essence a tube having an internal channel with an internal surface for contacting liquid and an external surface. The pipette has a first end that engages the gasket of the aspirating nipple where liquid may be drawn into the internal channel and in contact with internal surface extending through the first end toward a second end of the pipette. The size of the pipette is not particularly limited and it is selected such that it engages the gasket where liquid from the receptacle may be transferred to the internal channel of the pipette and selected such that the external surface of the pipette to come in contact with the liquid.

The term “gasket” as it is used in connection with the aspirating nipple is herein understood to mean the point of engagement between the pipette and the aspirating nipple. The gasket is sized to bring the interior of the pipette in contact with the liquid in the receptacle when the pipette is engaged with the aspirating nipple and when liquid is present in the receptacle. The gasket is further sized to prevent the exterior surface of the pipette from coming in contact with the liquid when the pipette is engaged with the nipple and when liquid is present in the container.

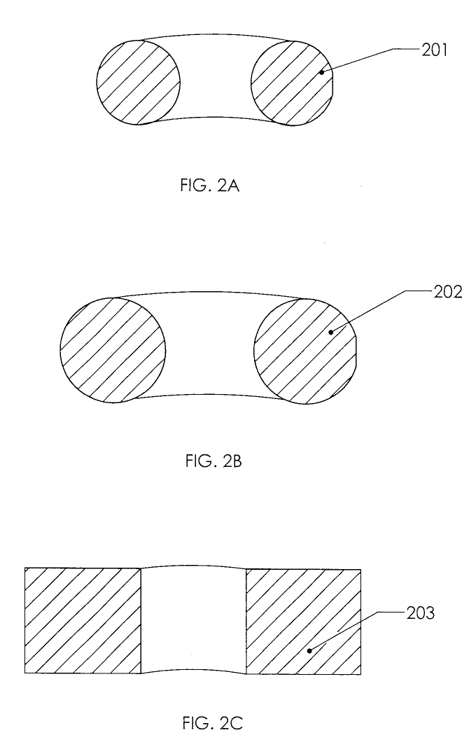

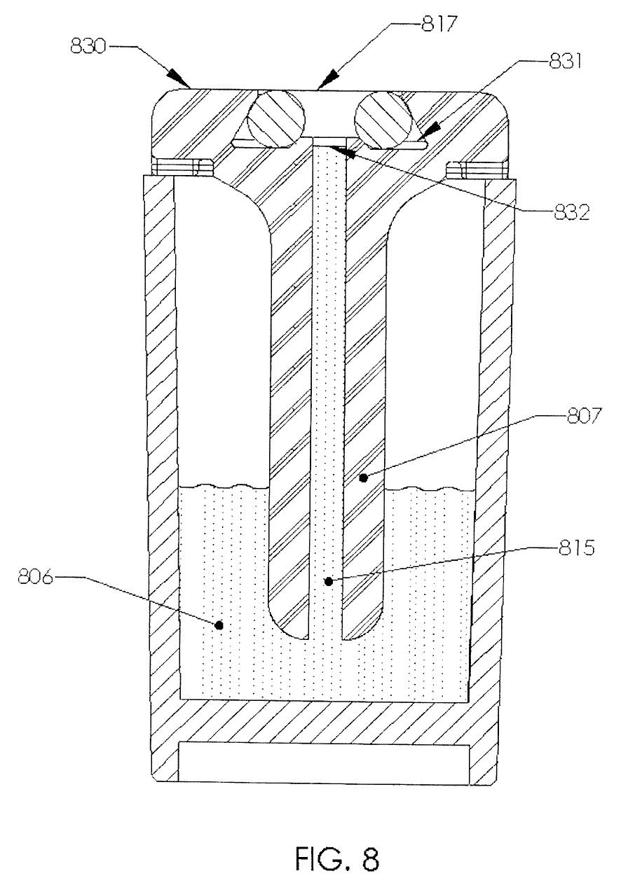

The material used for the gasket is not particularly limited provided that a seal can be formed by pressing the end of the pipette against the gasket. In preferred embodiments the gasket is a deformable ring that deforms to create a seal between the internal channel of the aspirating nipple and the inside of the pipette when the pipette is engaged therewith. In some embodiments the deformable ring will have a circular cross-section (201 shown in FIG. 2A), oval cross-section (202 shown in FIG. 2B), or rectangular cross-section (203 shown in FIG. 2C). In an additional embodiment the deformable ring may be made of polymeric material such as a rubber, polycarbonate, polyester, or other type of polymer. Preferably the polymeric material is selected such that it does not degrade when exposed to the liquid used in the container system. FIG. 8 illustrates the preferred gasket 817 of the present invention where a cross-section of the gasket is circular (i.e. where the gasket is an o-ring). Gasket 817 is a separate rubber ring 817 disposed around internal channel 815 of the aspirating nipple 807. When a pipette is engaged with the ring 817, the ring 817 may deform a distance 830 and within a gland space 831 within the nipple 807 to form a seal between the pipette and the ring 817. The size of the gasket is selected according to the size of the pipette and visa versa according to the above definition.

In some embodiments liquid is drawn from the receptacle into the internal channel of the nipple by capillary action. As demonstrated in FIG. 8, the capillary action created by the internal channel 815 allows for liquid 806 to be maintained at a level 832 at or near the gasket 817. This has the benefit of minimizing the air drawn into the pipette when it is engaged with the gasket 817.

In some embodiments, liquid is drawn from the receptacle into the pipette through the internal channel of the aspirating nipple by either capillary action or by applied force such as suction from a pneumatic or hydraulic device. Such a device may be either a bulb placed on the end of the pipette or a more complex computer driven device such as an automated liquid dispensing system (ALDS) as described below.

### The Container Systems:

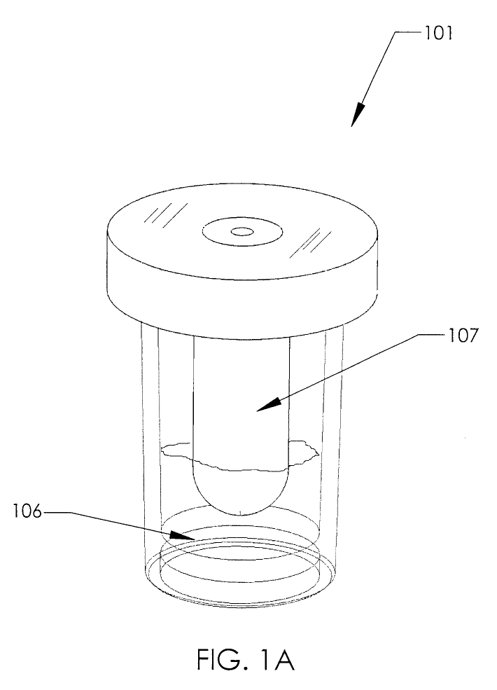

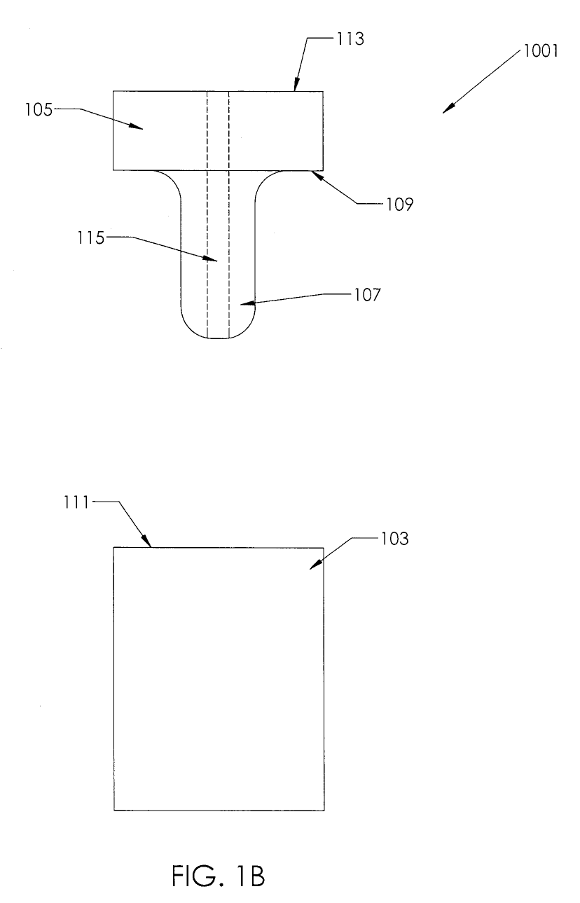

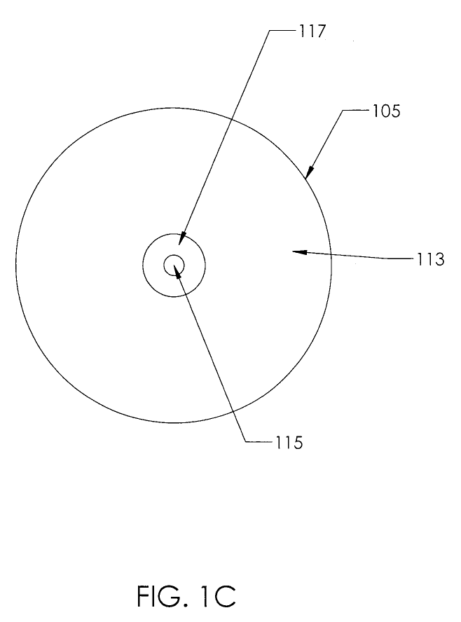

As shown in FIG. 1A a container 101 having an aspirating nipple 107 is provided. FIG. 1B details an exploded view of the container of the present invention. The container 1001 comprises an open-topped receptacle 103 for receiving a liquid 106, a cover 105 and an aspirating nipple 107. The cover 105 has an interior surface 109 fitting on or within the open top 111 of the receptacle 103 and an exterior surface 113 that it exposed when the cover 105 is fitted to the open top 111 of the receptacle 103. The cover 105 has an aspirating nipple 107 formed therein.

As shown in FIG. 1B the aspirating nipple 107 comprises a tube with an internal channel 115 extending from the exterior 113 of cover 105 into the receptacle 103 for transferring liquid 106 out of the receptacle 103. As shown in FIG. 1C, the cover 105 also has a gasket 117 disposed on the exterior surface 113 of the cover 105 and surrounding the channel 115.

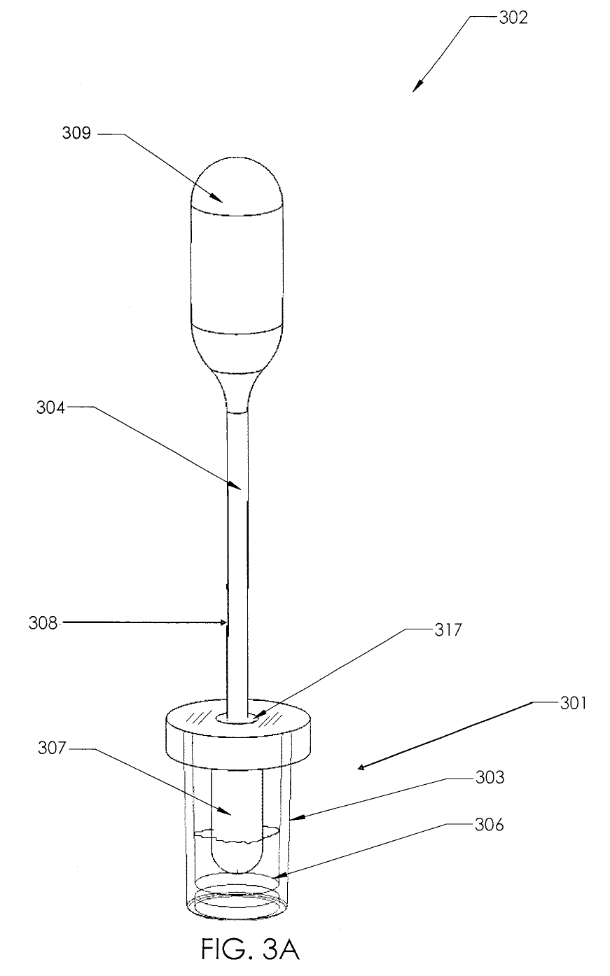

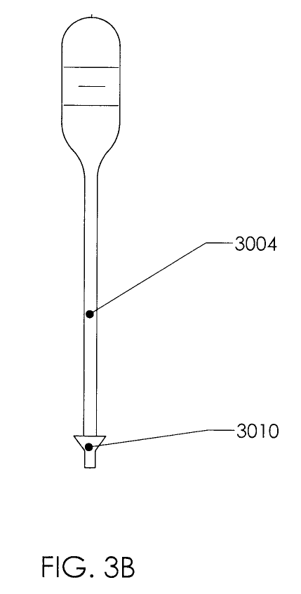

The present invention also provides container systems further comprising a pipette and in some embodiments a plurality of pipettes. For example in an embodiment of the present invention shown in FIG. 3A, the container system 302 comprises (i) a container 301 for a liquid 306; and (ii) a pipette 304 sized to engage the gasket 317 of the aspirating nipple 307. When liquid 306 is present in the receptacle 303 and the pipette 304 is engaged with the gasket 317 liquid 306 is transferred from receptacle 303 into the pipette 317 using suction bulb 309 without the exterior surface 308 of the pipette 304 being exposed to the liquid 306. In accordance with the embodiments provided herein and as shown in FIG. 3B the pipette 3004 may further comprises a disposable tip 3010. U.S. Pat. No. 4,487,081, which is incorporated herein for all purposes by reference thereto, discloses the use of disposable tips on pipettes such that after an tip has been used it is removed and a new tip may be employed. The use of a disposable tip 3010 further allows for the increased measurement accuracy that is required in the laboratory and manufacturing settings described herein that employ the container systems and methods of the present invention. Where pipette 3004 comprises disposable tip 3010 a disposable tip 3010, it is the disposable tip 3010 that engages the gasket of the aspirating nipple.

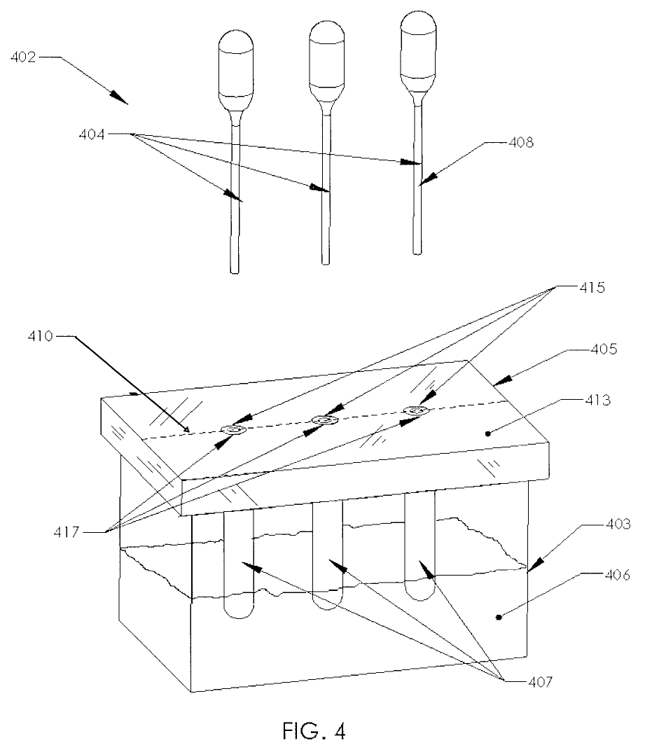

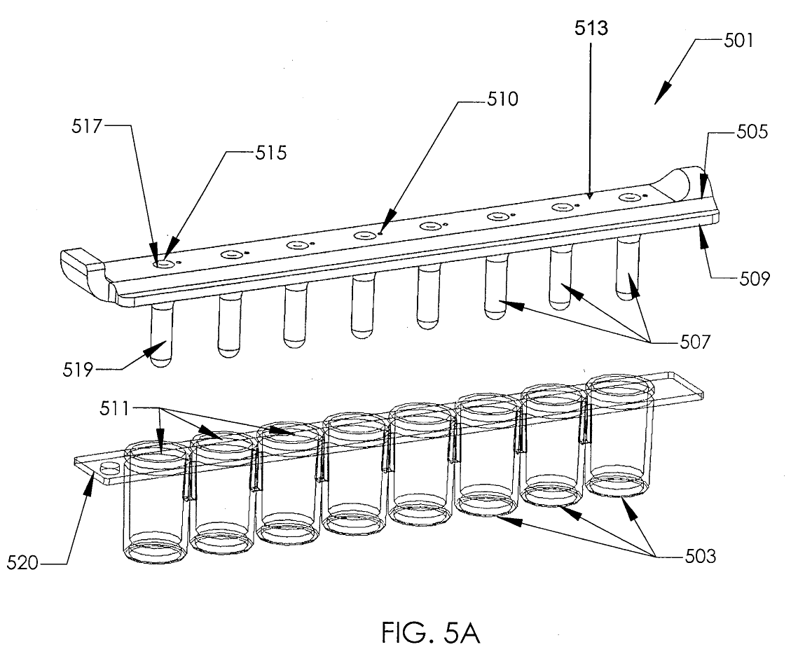

In a further embodiment of the present invention as shown in FIG. 4, the cover 405 has a plurality of aspirating nipples 407. Each aspirating nipple 407 is as described above in that it comprises a tube with an internal channel 415 extending from the exterior 413 of cover 405 into the receptacle 403 for transferring liquid 406 out of the receptacle 403. Furthermore each of the aspirating nipples 407 has an associated gasket 417 disposed on the exterior surface 413 of the cover 405 and surrounding the channel 415. In the embodiment shown in FIG. 4, each of the plurality of aspirating nipples 407 are arranged about the cover 405 in a line 410, but other geometries can be used. In the embodiment shown in FIG. 4 the container system 402 further comprises a plurality of pipettes 404 each associated with its own aspirating nipple 407 and sized to engage the associated gasket 417. When liquid 406 is present in the receptacle 403 and a pipette 404 is engaged with a gasket 417, liquid 406 is transferred from receptacle 403 into the pipette 404 without the exterior surface 408 of the pipette 404 being exposed to the liquid 403. In the embodiment shown in FIG. 4, the gaskets 417 are aligned in line 410 on the exterior 413 of the cover 405, however other geometries may be used.

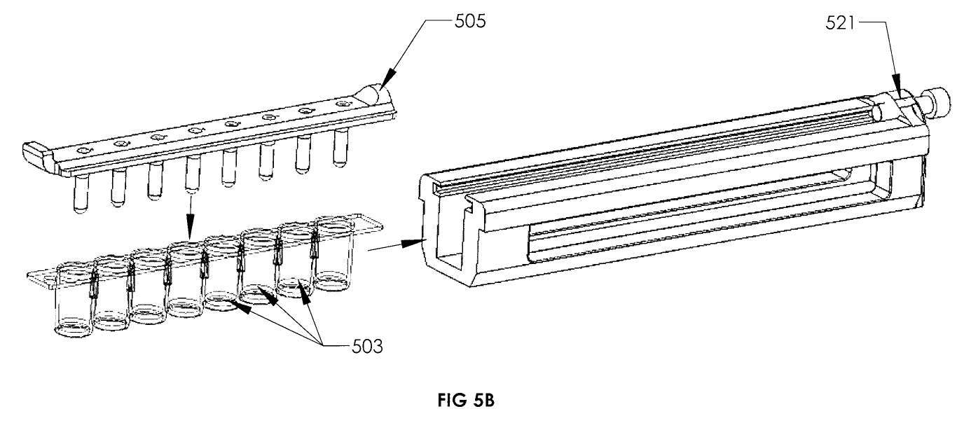

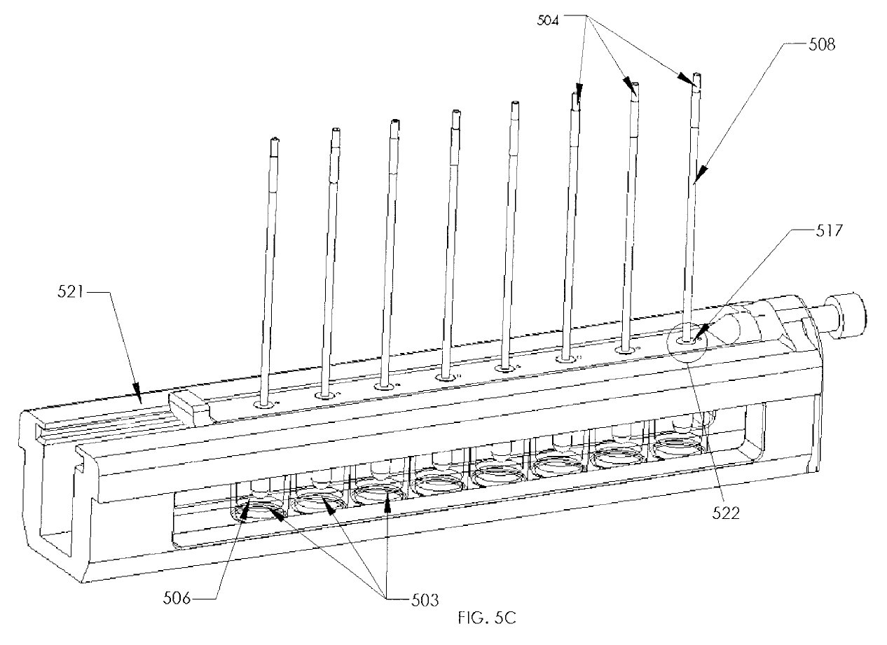

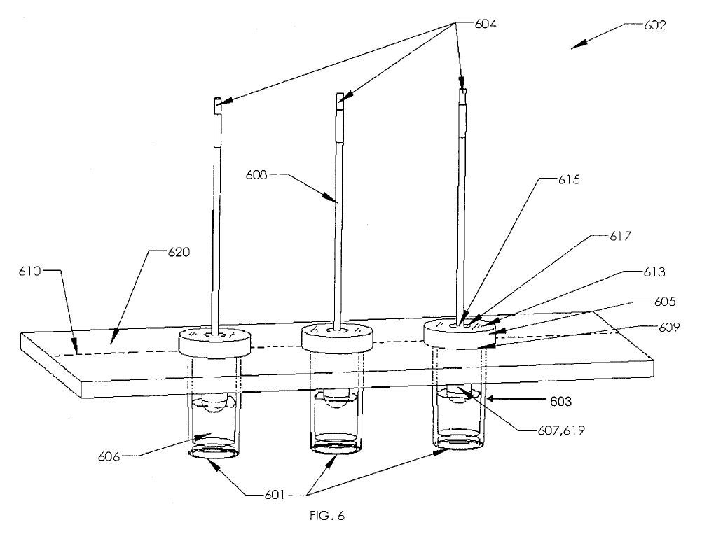

In yet another embodiment a container system 501 shown in FIG. 5A has a plurality of open-topped receptacles 503 for receiving a liquid and a cover 505. The cover 505 has an interior surface 509 fitting on or within the open tops 511 of the plurality of receptacles 503 and an exterior surface 513 that it exposed when the cover 505 is fitted to the open tops 511 of the receptacles 503. The cover 505 also has a plurality of aspirating nipples 507 formed therein. Each nipple 507 is associated with a respective receptacle 503. The plurality of aspirating nipples 507 each comprise a tube 519 with an internal channel extending from the exterior 513 of the cover 505 into the respective receptacle 503 for transferring liquid out of the respective receptacle 503. The nipples 507 also have a gasket 517 disposed on the exterior surface 513 of the cover 505 and surrounding the channel 515. The liquid used in the plurality of receptacles may be the same or different.

In the embodiment depicted in FIG. 5A, the gaskets 517 are disposed about the exterior surface 513 of the cover 505 in a line 510 although other geometries can be used. Furthermore in this embodiment the system 501 also comprises receptacle tray 520. The receptacle tray 520 is sized to receive the plurality of receptacles 503 and align them with the aspirating nipples 507.

In the further embodiment depicted in FIG. 5B, after the cover 505 has been placed in contact with receptacles 503 a holding jig 521 may lock the two together (as demonstrated in FIG. 5C). FIG. 5C also depicts a plurality of pipettes 504, each associated with a respective receptacle 503 and respective gasket 517. Each pipette 504 is sized to engage 522 a respective gasket 517. When a pipette is engaged 522 with a gasket 517 liquid 506 may be transferred from the receptacle 503 into the pipette 504 without the exterior surface 508 of the pipette 504 being exposed to the liquid 506.

In yet another embodiment the present invention provides a container system 602 shown in FIG. 6 having a plurality of containers 601 for liquids 606 and a plurality of pipettes 604. Each container 601 comprises an open-topped receptacle 603 for receiving a liquid 606 and a cover 605. The cover 605 has an interior surface 609 fitting on or within the open top of the receptacle 603 and an exterior surface 613 that it exposed when the cover 605 is fitted to the open top of the receptacle 603. The cover 605 also has an aspirating nipple 607 formed therein. The aspirating nipple 607 comprises a tube 619 with an internal channel extending 615 from the cover 605 into the receptacle 603 for transferring liquid 606 out of the receptacle 603 and a gasket 617 disposed on the exterior surface 613 of the cover 605 and surrounding the channel 615. The plurality of pipettes 604 are each associated with a respective gasket 617 and sized to engage the gasket 617. When the pipette 604 is engaged with the gasket 615 liquid 606 may be transferred from receptacle 603 into the pipette 604 without the exterior surface 608 of the pipette 604 being exposed to the liquid 606.

In the preferred embodiment depicted in FIG. 6 the container system 602 further comprises a container tray 620. The container tray 620 is sized to receive the plurality of containers 601 and align them such that the gaskets are in a line 610.

### A Method of Using the Container System:

The present invention also provides a method of using a container system. In accordance with the present invention the method comprises the steps of:

(i) providing a container system for a liquid comprising:

an open-topped receptacle for receiving a liquid,

a liquid received in the open-topped receptacle

a cover, said cover having an interior surface fitting on or within the open top of the receptacle and an exterior surface that it exposed when the cover is fitted to the open top of the receptacle, said cover having an aspirating nipple formed therein,

wherein the aspirating nipple comprises a tube with an internal channel extending from the exterior of the cover into the receptacle for transferring liquid out of the receptacle, and a gasket disposed on the exterior surface of the cover and surrounding the channel,

(ii) providing a pipette sized to engage the gasket, wherein when liquid is present in the receptacle and the pipette is engaged with the gasket liquid may be transferred from receptacle into the pipette without the exterior surface of the pipette being exposed to the liquid,
(iii) contacting the pipette with the gasket,
(iv) transferring liquid from the open-topped receptacle into the pipette through the aspirating nipple, and
(v) discharging the transferred liquid to a target location.

Steps (iii), (iv), and (v) may be repeated as desired by the user. In the embodiments described above where the pipette further comprise a disposable tip, the method will further comprise the steps of introducing a disposable tip to the pipette prior to contacting the pipette with the gasket, and removing the disposable tip from the pipette after the transferred liquid is discharged to a target location. Again these additional steps may be repeated together with steps (iii), (iv), and (v) as desired by a user.

As described herein the container systems of the present invention may consist of a single pipette and a single aspirating nipple. In such an embodiment the container system may be suitable for use in a single application setting such as where a laboratory technician requires the addition a precise measurement of sample for a particular purpose. In other embodiments where a plurality of pipettes and aspirating nipples are employed, the number of such is not particularly limited. For example the number may be a whole integer from 1 to 50 or more (e.g. 10, 20, 30, 40, or 50).

It is contemplated that the container systems of the present invention may be used in combination with automated liquid dispensing systems (ALDS). As described in U.S. Pat. Nos. 5,882,930, 5,104,621, and 4,422,151 which are herein incorporated for all purposes by reference thereto, ALDSs allow for the manufacture and preparation of multiple assays in an efficient manner.

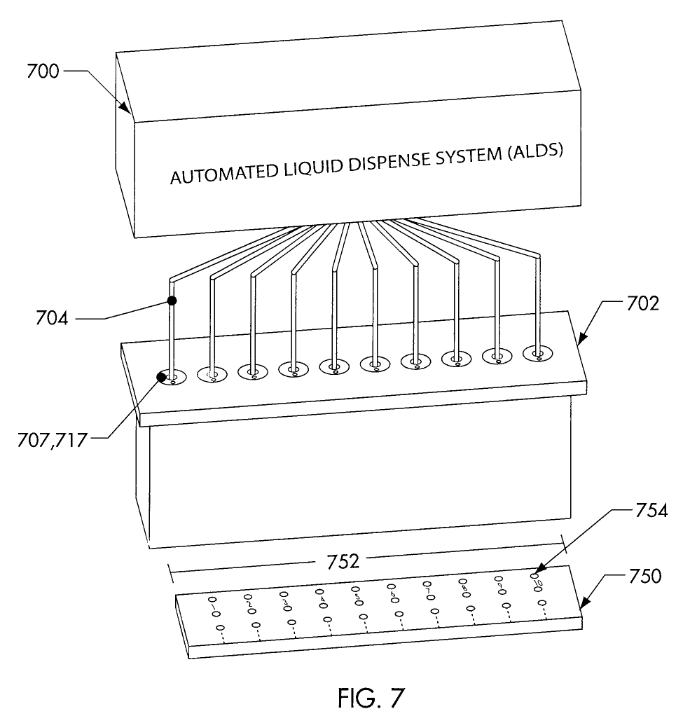

In one embodiment the combined container system and ALDS systems is suited for and employed in, inter alia, a laboratory settings where reagent test trays are prepared for subsequent assays and/or other chemical tests. In these settings it is contemplated that the number of pipettes and aspirating nipples will correspond to the number of desired tests per row or per column. For example as depicted in FIG. 7, an ALDS 700 will incorporate a container system 701 of the present invention. A sample assay test tray 750 will have for example ten sample wells 754 spanning the width 752 of the tray 750. Therefore in the present embodiment the container system 702 will preferably also comprise ten a pipettes 704, ten aspirating nipples 707 with ten gaskets 717 that correspond to the number of samples wells 754. During the automated preparation of an assay tray 750 for subsequent tests, an ALDS 700 engages the plurality of pipettes 704 with the gaskets 717 to transfer liquid from the container(s)/receptacle(s) into the pipettes without contacting the exterior of the pipettes with the liquid. The ALDS 700 will then position the pipettes over the sample wells 754 of tray 750 and dispense the liquid into the well 754. Depending upon the programmed operation of the ALDS, the ALDS then may directly position the pipettes above a second row or column to dispense liquid into another set of sample wells, or the ALDS may bring the pipettes back in contact with the aspirating nipples via the gaskets to obtain more liquid.

In other embodiments such an ALDS would also be useful in a manufacturing process to produce diagnostic test strips that require a precise measurement reagent (that is applied as a liquid and subsequently dried during the manufacturing process) within the testing area of the strip. See U.S. patent application Ser. No. 10/908,656 which is incorporated herein for all purposes by reference thereto. For example, electrochemical test strips used to determine the concentration or presence of analytes such as glucose in biological fluids such as blood require the presence of precise and predetermined amounts of chemical reagent such as an oxidation and/or reduction enzyme, inter alia. The container systems of the present invention could be used in combination with an ALDS on a production line to mass produce these test strips wherein the ALDS would bring the pipettes in contact with the container systems comprising the liquid chemical reagent and then dispense the liquid chemical reagent in the predetermined amounts to test strips during mass production.

ALDSs have also proven useful in the preparation of other products as well. For example ALDS are useful in production processes for foods, beverages, and other products that are liquid. In one embodiment the container systems and methods of the present invention may be used on a production lines for dispense liquid beverages (e.g. soda or juice) or products (e.g. paint) into product containers that are sold to consumer on the shelves of grocery and hardware stores. Nonetheless the Inventors of the present invention do not intend to be bound to a specified use of the containers and methods of the present invention as those skilled in the art may easily envision a myriad of potential uses for the container systems and methods of the present invention and such uses are intended to fall within the scope of the present invention.

1. A container system for a liquid, the system comprising:
an open-topped receptacle for receiving a liquid,
a cover, said cover having an interior surface fitting on or within the open top of the receptacle and an exterior surface that it exposed when the cover is fitted to the open top of the receptacle, said cover having an aspirating nipple formed therein,
wherein the aspirating nipple comprises a tube with an internal channel extending from the exterior of the cover into the receptacle for transferring liquid out of the receptacle, and a gasket disposed on the exterior surface of the cover and surrounding the channel.

2. The system of claim 1, wherein the gasket is a polymeric ring.

3. The system of claim 1, wherein liquid is present in the receptacle and the liquid is a chemical reagent.

4. The system of claim 1, further comprising a pipette sized to engage the gasket, wherein when liquid is present in the receptacle and the pipette is engaged with the gasket liquid may be transferred from receptacle into the pipette without the exterior surface of the pipette being exposed to the liquid.

5. The system of claim 4, wherein the pipette further comprises a disposable tip.

6. The system of claim 1, wherein the cover has a plurality of aspirating nipples, each aspirating nipple comprises a tube with an internal channel extending from the cover into the receptacle for transferring liquid out of the receptacle and a gasket disposed on the exterior surface of the cover and surrounding the channel.

7. The system of claim 6, wherein the gaskets are arranged about the exterior of the cover in a line.

8. The system of claim 6, wherein the gaskets are polymeric rings.

9. The system of claim 6, wherein liquid is present in the receptacle and the liquid is a chemical reagent.

10. The system of claim 6, further comprising a plurality of pipettes, each pipette associated with a different aspirating nipple and sized to engage the associated gasket, wherein when liquid is present in the receptacle and a pipette is engaged with a gasket, liquid may be transferred from receptacle into the pipette without the exterior surface of the pipette being exposed to the liquid.

11. The system of claim 10, wherein the gaskets are arranged about the exterior of the cover in a line.

12. The system of claim 10, wherein the pipettes further comprise disposable tips.

13. A container system for a liquid, the system comprising:
a plurality of open-topped receptacles for receiving a liquid,
a cover, said cover having an interior surface fitting on or within the open tops of the plurality of receptacles and an exterior surface that it exposed when the cover is fitted to the open tops of the receptacles, said cover having a plurality of aspirating nipples formed therein each associated with a respective receptacle,
wherein the plurality of aspirating nipples each comprise a tube with an internal channel extending from the cover into the respective receptacle for transferring liquid out of the respective receptacle, and a gasket disposed on the exterior surface of the cover and surrounding the channel.

14. The system of claim 13, wherein the gaskets are polymeric rings.

15. The system of claim 13, wherein liquid is present in the receptacle and the liquid is a chemical reagent.

16. The system of claim 13, wherein the gaskets are disposed about the exterior surface of the cover in a line and wherein the system further comprises receptacle tray wherein the receptacle tray is sized to receive the plurality of receptacles and align them with the aspirating nipples in a line.

17. The system of claim 13, further comprising a plurality of pipettes each associated with a respective receptacle and each pipette sized to engage a respective gasket, wherein when a pipette is engaged with a gasket liquid may be transferred from the receptacle into the pipette without the exterior surface of the pipette being exposed to the liquid.

18. The system of claim 17, wherein the pipettes further comprise disposable tips.

19. The system of claim 17, wherein the gaskets are polymeric rings.

20. The system of claim 17, wherein liquid is present in the receptacle and the liquid is a chemical reagent.

21. The system of claim 17, wherein the gaskets are disposed about the exterior surface of the cover in a line and wherein the system further comprises receptacle tray wherein the receptacle tray is sized to receive the plurality of receptacles and align them with the aspirating nipples.

22. A container system for a liquid, the system comprising:
(i) a plurality of containers for liquids, each container comprising:
an open-topped receptacle for receiving a liquid,
a cover, said cover having an interior surface fitting on or within the open top of the receptacle and an exterior surface that it exposed when the cover is fitted to the open top of the receptacle, said cover having an aspirating nipple formed therein,
wherein the aspirating nipple comprises a tube with an internal channel extending from the cover into the receptacle for transferring liquid out of the receptacle, and a gasket disposed on the exterior surface of the cover and surrounding the channel, and
(ii) a plurality of pipettes each associated with a respective gasket and sized to engage the gasket, wherein when the pipette is engaged with the gasket liquid may be transferred from receptacle into the pipette without the exterior surface of the pipette being exposed to the liquid.

23. The system of claim 22, wherein the gaskets are polymeric o-rings.

24. The system of claim 22, wherein liquid is present in the receptacle and the liquid is a chemical reagent.

25. The system of claim 22, wherein the system further comprises container tray, wherein the container tray is sized to receive the plurality of containers and align them such that the gaskets are in a line.

26. The system of claim 22, wherein the pipettes further comprise disposable tips.

27. A method of using a container system for a liquid, the method comprising the steps of:
(i) providing a container system for a liquid comprising:
an open-topped receptacle for receiving a liquid,
a liquid received in the open-topped receptacle,
a cover, said cover having an interior surface fitting on or within the open top of the receptacle and an exterior surface that it exposed when the cover is fitted to the open top of the receptacle, said cover having an aspirating nipple formed therein,
wherein the aspirating nipple comprises a tube with an internal channel extending from the exterior of the cover into the receptacle for transferring liquid out of the receptacle, and a gasket disposed on the exterior surface of the cover and surrounding the channel,
(ii) providing a pipette sized to engage the gasket, wherein when liquid is present in the receptacle and the pipette is engaged with the gasket liquid may be transferred from receptacle into the pipette without the exterior surface of the pipette being exposed to the liquid,
(iii) contacting the pipette with the gasket,
(iv) transferring liquid from the open-topped receptacle into the pipette through the aspirating nipple without exposing the exterior surface of the pipette to the liquid, and
(v) discharging the transferred liquid to a target location.

28. The method of claim 27, wherein steps (iii), (iv), and (v) are repeated.

29. The method of claim 27, further comprising the steps of introducing a disposable tip to the pipette prior to contacting the pipette with the gasket, and removing the disposable tip from the pipette after the transferred liquid is discharged to a target location.

30. The method of claim 29, wherein steps (iii), (iv), and (v) are repeated together with the steps of introducing a disposable tip to the pipette prior to contacting the pipette with the gasket, and removing the disposable tip from the pipette after the transferred liquid is discharged to a target location.
